(19) United States
(12) Patent Application Publication
(10) Pub. No.: US 2022/0074445 A1
(43) Pub. Date: Mar. 10, 2022

(54) Fastener Retainer

(71) Applicant: APQ Development, LLC, Jackson, MI (US)

(72) Inventors: Lee McLain, Jonesville, MI (US); Justin Joughin, Morenci, MI (US)

(73) Assignee: APQ Development, LLC, Jackson, MI (US)

(21) Appl. No.: 17/014,597

(22) Filed: Sep. 8, 2020

(51) Int. Cl. F16B 41/00; F16B 19/02; F16B 43/00

(52) U.S. Cl. CPC F16B 41/002; F16B 43/00; F16B 19/02

(57) ABSTRACT

A mounting feature for an attachable component includes a mounting tab and an integrated retaining feature. The mounting tab includes a tab body having a first end surface and a second end surface formed on an opposite side from the first end surface. A distance from the first end surface to the second end surface defines a thickness of the mounting tab. The mounting tab further includes an inner wall defining a socket having a first width that extends through the thickness of the tab body from a first end at the first end surface of the tab body to a second end at the second end surface of the mounting tab. The retaining feature is disposed within the second of the socket and includes a receptacle having a second width that is less than the first width of the socket. The receptacle is configured to capture fastener shank.

### TECHNICAL FIELD

This disclosure relates to a fastener retainer, and more particularly to a fastener retainer for an attachable component.

### BACKGROUND

Mechanical fasteners, such as bolts, screws, and rivets, are often used to attach accessory components to a primary structure. For example, one or more threaded fasteners may engage a mounting interface of a primary structure (e.g., vehicle frame or body) to secure an accessory component (e.g., a component housing) to the primary structure. In some instances, it may be desirable to configure the accessory component such that the mechanical fasteners are retained within a mounting portion of the accessory component prior to attachment to mounting interface of the primary structure.

### SUMMARY

One aspect of the disclosure provides a mounting feature for an attachable component. The mounting feature includes a mounting tab having a tab body and an inner wall. The tab body includes a first end surface and a second end surface formed on an opposite side from the first end surface. A distance from the first end surface to the second end surface defines a thickness of the tab body. The inner wall defines a socket having a first width extending through the thickness of the tab body from a first end at the first end surface of the tab body to a second end at the second end surface of the tab body. The mounting feature further includes a retaining feature disposed within the second of the socket. The retaining feature include a receptacle having a second width that is less than the first width of the socket.

Implementations of the disclosure may include one or more of the following optional features. In some implementations, the retaining feature is an annular retainer ring including an inner surface defining the receptacle and an outer surface formed on an opposite side of the retaining feature than the inner surface. Here, the outer surface of the retaining feature may be spaced apart from the inner wall of the socket of the mounting tab. In some examples, the outer surface of the retaining feature is connected to the inner wall of the socket of the mounting tab by one or more protuberances. Optionally, the one or more protuberances includes a plurality of protuberances. Each of the protuberances of the plurality of protuberances is spaced apart from one another along the outer surface of the retaining feature.

In some examples, the mounting feature includes a compression limiter disposed within the socket of the mounting tab. Optionally, the compression limiter is disposed between the inner wall of the mounting tab and the retaining feature. Here, the compression limiter may extend from the first end of the socket to the second end of the socket. In some examples, the compression limiter includes an inner surface defining a conduit having a third width that is less than the first width of the socket and greater than the second width of the retaining feature. Optionally, the mounting features includes a fastener including a shank having a major diameter that is greater than the second width and less than the third width.

Another aspect of the disclosure provides a mounting feature for an attachable component. The mounting feature includes a mounting tab and a retaining feature. The mounting tab includes an inner wall defining a socket extending through the mounting tab, where the socket has a first width. The retaining feature includes a retainer ring disposed within the socket. The retainer ring includes an outer surface that is spaced apart from the inner wall of the socket by a gap and an inner surface that is formed on an opposite side from the outer surface and defines a receptacle having a second width that is less than the first width. This aspect may include one or more of the following optional features.

In some implementations, the inner wall of the mounting tab is cylindrical and retaining feature comprises an annular retainer ring. Optionally, the annular retainer ring is concentric with the inner wall of the mounting tab. In some examples, the outer surface of the retaining retainer ring is connected to the inner wall of the socket of the mounting tab by one or more protuberances. Here, the one or more protuberances may include a plurality of protuberances, where each of the protuberances of the plurality of protuberances is spaced apart from one another along the outer surface of the retaining feature.

In some examples, the mounting feature includes a compression limiter disposed within the socket of the mounting tab. Here, the compression limiter is disposed between the inner wall of the socket and the retaining feature. In some examples, the compression limiter includes an inner surface defining a conduit having a third width that is less than the first width of the socket and greater than the second width of the retaining feature. Here, the retaining feature is disposed adjacent to an end of the socket of the mounting tab. In some examples, the mounting feature has a fastener including a shank having a major diameter that is greater than the second width.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is top perspective view of a component including an example of a fastener retainer.

FIG. 2 is a bottom perspective view of the component of FIG. 1.

FIG. 3 is partially-exploded, enlarged perspective view of the component of FIG. 1, taken at Area 3 in FIG. 2.

FIG. 4 is a cross-sectional view of the component of FIG. 1, taken along Line 4-4 of FIG. 3.

FIG. 5A is an enlarged cross-sectional view of the component of FIG. 1, taken at Area 5 of FIG. 4 and showing a fastener installed within the fastener retainer.

FIG. 5B is an enlarged cross-sectional view of the component of FIG. 1, taken at Area 5 of FIG. 4 and showing the fastener removed from the fastener retainer.

FIG. 6 is a cross-sectional view of the component of FIG. 1, taken along Line 6-6 of FIG. 3.

FIG. 7A is an enlarged cross-sectional view of the component of FIG. 1, taken at Area 7 of FIG. 6 and showing a fastener installed within the fastener retainer.

FIG. 7B is an enlarged cross-sectional view of the component of FIG. 1, taken at Area 7 of FIG. 6 and showing the fastener separated from the fastener retainer.

Like reference symbols in the various drawings indicate like elements.

### DETAILED DESCRIPTION

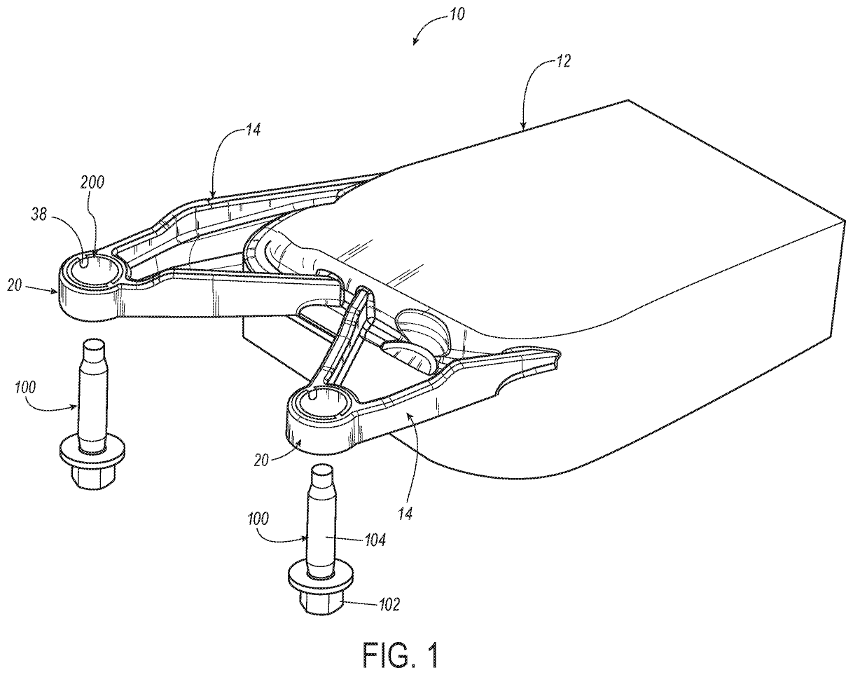

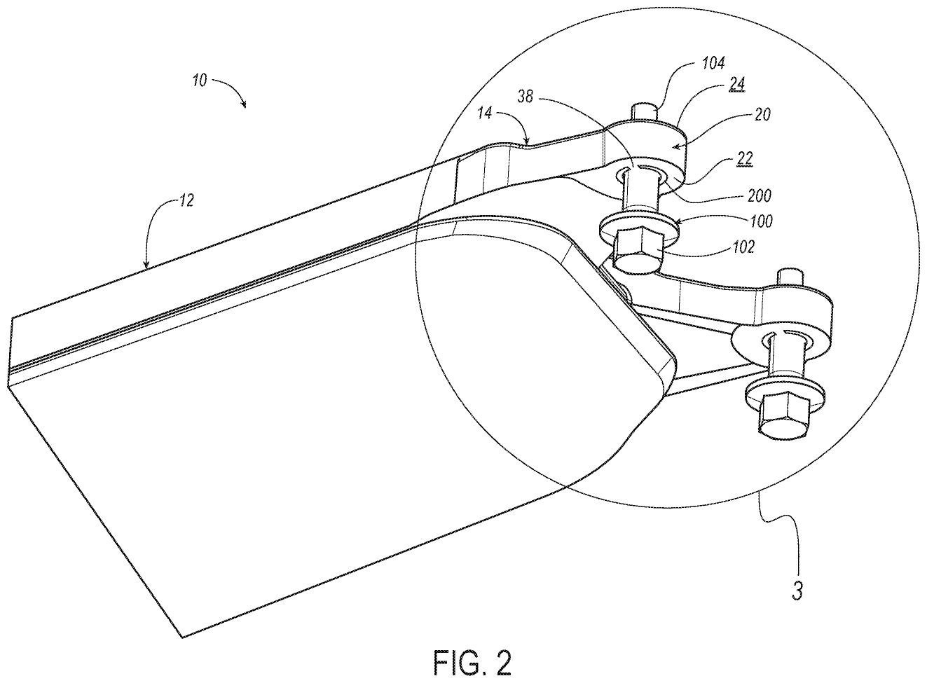

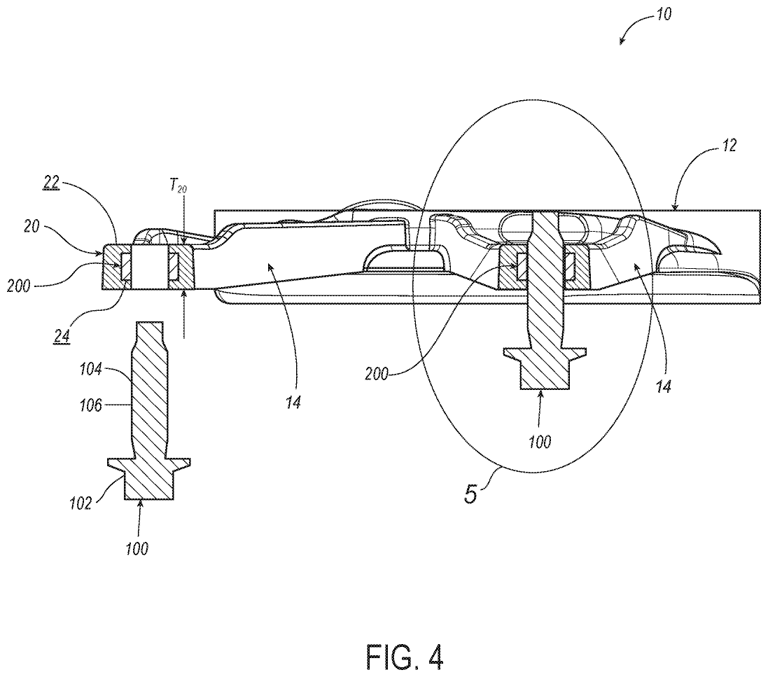

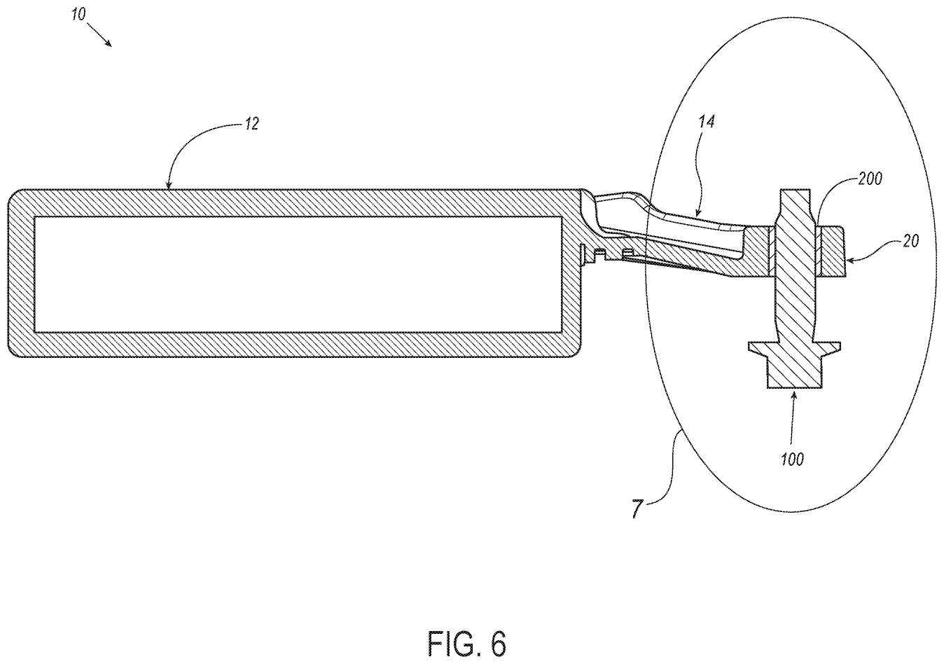

Referring to FIGS. 1-7B, in some implementations, a module or component 10 includes a housing 12 and one or more mounting tabs 14 configured for selectively attaching the component 10 to a parent structure. For example, modules or components 10 may include components of vehicle or building subsystems that are configured to be coupled to a parent structure (e.g., vehicle frame, building structure) using one or more fasteners 100. Optionally, each of the one or more mounting tabs 14 may include a compression limiter 200 disposed therein, which is configured to prevent the fastener 100 from deforming the mounting tab 14 when the fastener 100 is secured to the parent structure.

While the example provided in this disclosure is directed towards a component 10 having a generic housing 12, the mounting tabs 14 could be incorporated into any component configured for attachment using mechanical fasteners 100. Furthermore, although the illustrated example of the component 10 includes a pair of the mounting tabs 14 extending from one side of the housing 12, in other examples a component may include a single one of the mounting tabs 14 or a plurality of the mounting tabs 14 extending from different sides of the component.

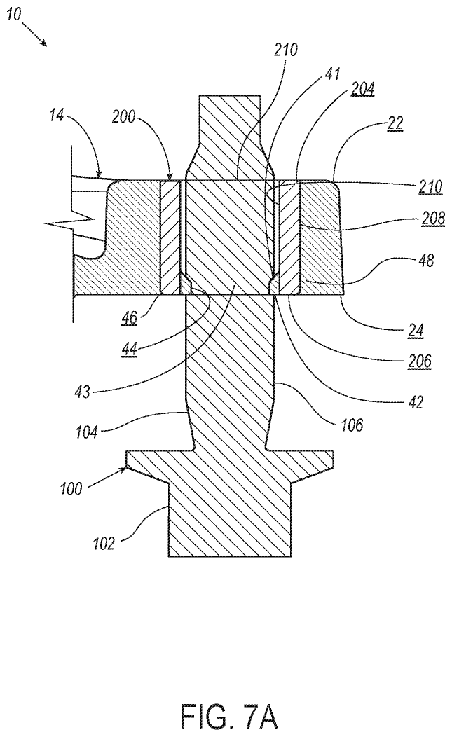

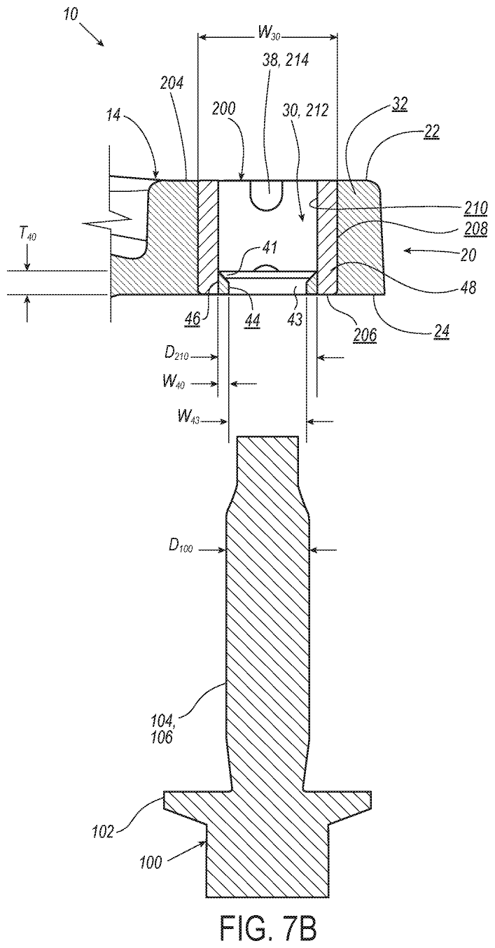

As discussed throughout this disclosure, the fasteners 100 may include a fastener head 102 and a fastener shank 104 extending from the fastener head 102 along a longitudinal axis A_{104.} The fastener shank 104 may include a threaded portion 106, which defines a major diameter D₁₀₀ (FIG. 7B) of the fastener 100. While the illustrated fastener 100 includes a bolt, the present disclosure may also apply to different types of fasteners, such as screws or pins.

Each of the mounting tabs 14 includes a tab body 20 having a first end surface 22 and a second end surface 24 disposed on an opposite side of the tab body 20 than the first end surface 22. Accordingly, a distance from the first end surface 22 to the second end surface 24 defines a thickness T₂₀ of the tab body 20. The first end surface 22 may define a mounting plane of the component 10, which is configured to interface with a corresponding mounting plane of a mounting structure when the component 10 is attached to the parent structure. Conversely, the second end surface 24 defines a clamping surface of the component 10, which is configured to interface with a clamping feature of the fastener 100, such as a washer or the fastener head 102. Accordingly, the first end surface 22 and the second end surface 24 may be parallel to one another, such that a clamping force applied to the second end surface 24 is transmitted through the thickness T₂₀ of the tab body 20 to secure the first end surface 22 against the mounting surface of the parent structure.

With reference to FIG. 7B, the tab body 20 includes an aperture or socket 30 extending through the thickness T₂₀ of the tab body 20. Here, the socket 30 is defined by an inner wall 32 extending continuously from a first end 34 at the first end surface 22 to a second end 36 at the second end surface 24. The inner wall 32 of the socket 30 defines a width W₃₀ of the socket 30. In the illustrated example, the inner wall 32 is cylindrical such that the width W₃₀ of the socket 30 is a diameter. However, in other examples, the inner side surface may have a polygonal or irregular cross-sectional shape.

The socket 30 may include one or more protuberances 38 projecting radially inwardly from the inner wall 32 of the socket 30. In the illustrated example, the socket 30 includes a first pair of the protuberances 38 disposed at the first end 34 of the socket 30 and a second pair of the protuberances 38 disposed at the second end 36 of the socket 30. The protuberances 38 of each pair of protuberances 38 are diametrically opposed to one another across the socket 30. As discussed in greater detail below, the protuberances 38 may interface with corresponding features of the compression limiter 200 to prevent rotational and axial movement of the compression limiter 200 within the tab body 20.

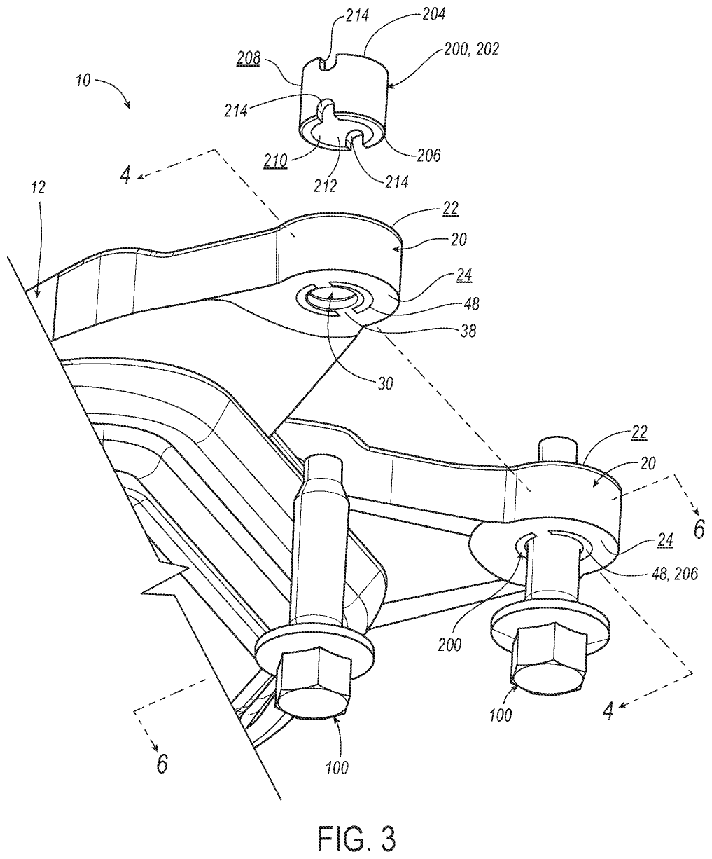

With reference to FIGS. 3-7A, each mounting tab 14 includes a retaining feature 40 configured to capture the fastener 100 within the socket 30 prior to installation of the component 10 on the parent structure. In the illustrated example, the retaining feature 40 is a retainer ring 40 disposed within the socket 30. Particularly, where the inner wall 32 of the socket 30 is cylindrical, the retaining feature is provided as an annular retainer ring 40 within the second end 36 of the socket 30.

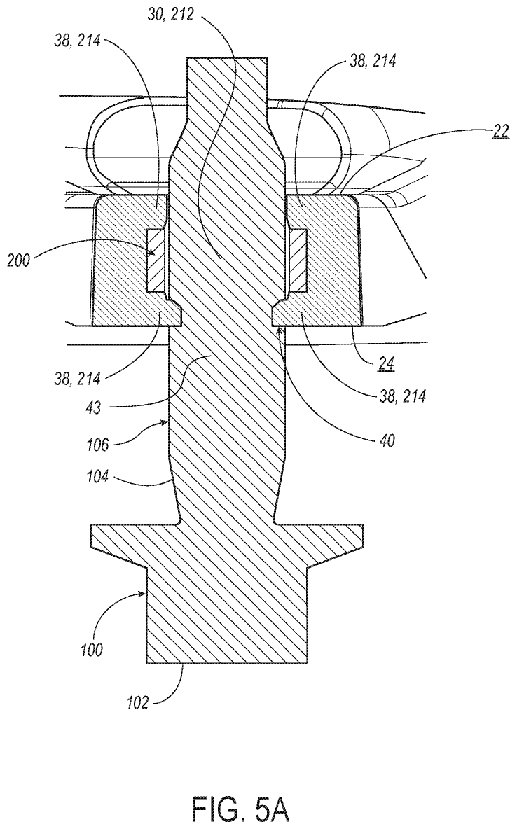

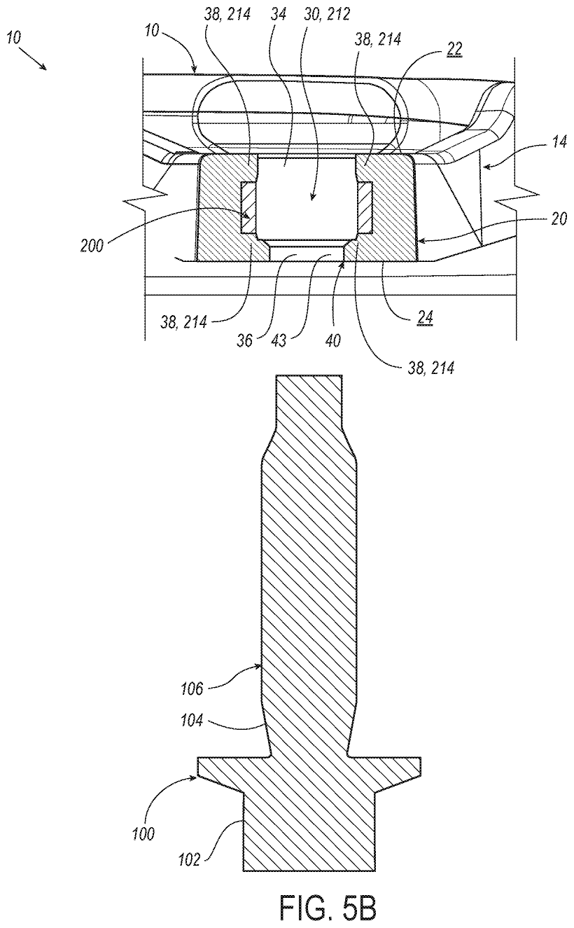

The retainer ring 40 extends from a first end 41 to a second end 42 formed on an opposite end than the first end 41. A distance from the first end 41 to the second end 42 defines an axial thickness T₄₀ of the retainer ring 40. As best shown in FIGS. 5A and 7A, the first end 41 of the retainer ring 40 is disposed within the socket 30 between the first end surface 22 and the second end surface 24, while the second end 42 of the retainer ring 40 is flush with the second end surface 24. Optionally, the first end 41 of the retainer ring 40 is beveled such that the thickness T₄₀ of the retainer ring 40 tapers in a radially-inwardly direction.

The retaining feature 40 includes a receptacle 43 defined by an inner surface 44. As shown, the inner surface 44 is cylindrical and is concentric with the inner wall 32 of the socket 30. The inner surface 44 of the receptacle 43 is configured to form an interference fit between the retaining feature 40 and the fastener shank 104. Specifically, the inner surface 44 of the retaining feature 40 defines a width W₄₃ or diameter of the receptacle 43 that is less than the major diameter D₁₀₀ of the fastener shank 104. Thus, the fastener shank 104 may form a press-fit or thread engagement with the inner surface 44 of the receptacle 43 when the fastener shank 104 is inserted into the receptacle, as best shown in FIGS. 5A and 7A.

Referring ring still to FIGS. 3-7B, the retainer ring 40 may include an outer surface 46 forming an outer circumference of the retainer ring 40 on an opposite side of the inner surface 44. A distance from the inner surface 44 to the outer surface 46 defines a radial width W₄₀ (FIG. 7B) of the retainer ring 40. In the illustrated example, the outer surface 46 of the retainer ring 40 is offset radially inwardly from the inner wall 32 of the socket 30. In other words, the outer surface 46 is spaced apart from the inner wall 32 by an annular gap 48 that surrounds the retainer ring 40.

With reference to FIGS. 3-5B, the retainer ring 40 may be connected to the tab body 20 by one or more of the protuberances 38. In other words, the protuberances 38 may form a link 38 extending across the gap 48 to connect the outer surface 46 of the retainer ring 40 to the inner wall 32 of the socket 30. The protuberances 38 are spaced apart from each other along the circumference (i.e., the outer surface 46) of the retainer ring 40 such that the gap 48 extends between adjacent ones of the protuberances 38. As provided above, the protuberances 38 of the present example include a pair of the protuberances 38 that are diametrically opposed to one another, such that the protuberances attach the retainer ring 40 to the tab body 20 on opposite sides of the retainer ring 40.

The retainer ring 40 may include a first material having a first hardness that is less than a material forming the fastener 100. For example, the inner surface 44 of the retainer ring 40 may be formed of a polymeric material having a first hardness and the threaded portion 106 of the fastener shank 104 may be formed of a material (e.g., metal, plastic) having a second hardness that is greater than the hardness of the first material forming the inner surface 44 of the retainer ring 40. In use, the fastener shank 104 is initially pressed or threaded into the receptacle 43 such that the inner surface 44 of the retainer ring 40 engages the threaded portion 106 of the fastener shank 104 to capture the fastener shank 104 within the tab body 20.

When the component 10 is attached to the parent structure and the fasteners 100 are threaded into corresponding mounting holes of the parent structure, helical threads on the threaded portion 106 of the fastener 100 will strip the material forming the inner surface 44 of the retainer ring 40 to allow the fastener 100 to rotate and translate freely relative to the retainer ring 40 and the socket 30. As discussed above, the first end 41 of the retainer ring 40 may be beveled. When present, the beveled configuration may minimize a torque require to strip the inner surface 44 of the retainer ring 40 by providing an angled transition between the first end 41 and the inner surface 44.

With reference to FIGS. 1-5, the compression limiter 200 includes a tubular bushing 202 extending from a first end 204 to a second end 206. The bushing 202 includes a cylindrical exterior surface 208 extending from the first end 204 to the second end 206 and a cylindrical interior surface 210 extending from the first end 204 to the second end 206. The exterior surface 208 defines an outside width of the bushing 202 configured to interface with the inner wall 32 of the socket 30. Specifically, the outside width of the bushing 202 is the same as the inside width W₃₀ of the inner wall 32. The interior surface 210 defines a conduit 212 extending through the entire length of the bushing 202. A width W₂₁₀ of the conduit 212, which is defined by the interior surface 210, is configured as a clearance hole for receiving the fastener shank 104. Accordingly, sizes of the inside width W₂₁₀ and may vary depending on a sizes of the socket 30 and the fastener 100.

Each of the first end 204 and the second end 206 of the bushing 202 are substantially planar, such that a distance from the first end 204 to the second end 206 defines a length of the bushing 202. Each end 204, 206 of the bushing 202 further includes at least one detent 214 formed as a notch extending continuously from the exterior surface 208 to the interior surface 210. As shown in FIG. 3, each end 204, 206 includes a pair of diametrically-opposed detents 214 having a shape and position configured to receive a corresponding one of the protuberances 38 of the socket 30.

When included, the bushing 202 extends from the first end 34 of the socket 30 to the second end 36 of the socket 30 such that the first end 204 of the bushing 202 is flush with the first end surface 22 of the tab body 20 and the second end 206 of the bushing 202 is flush with the second end surface 24 of the tab body 20. Accordingly, the second end 206 of the bushing 202 extends into the gap 48 formed between the retainer ring 40 and the inner wall 32 of the socket 30. Put another way, the retainer ring 40 is disposed within the conduit 212 of the compression limiter 200 and is connected to the inner wall 32 of the socket 30 by the protuberances 38 extending through the detents 214 formed in the second end 206 of the bushing 202.

The bushing 202 includes one or more materials configured to provide the bushing 202 with a relatively high hardness, whereby the compression limiter 200 is configured to withstand compressive forces imparted by a fastener 100. In some examples, the bushing 202 includes a metal alloy, such as carbon steel. More specifically, the bushing 202 may include 12L14 steel, or a mechanical equivalent. The bushing 202 may be carbonized of carbonitride to a minimum depth of 0.010″ to provide the surface with a hardness of at least Rockwell C HRC 30. The bushing 202 may also be zinc plated and baked for hydrogen embrittlement relief.

In use, the compression limiter 200 is implemented within one of the tab bodies 20 of the component 10. The compression limiter 200 may be co-molded with the component tab body 20 and the retainer ring 40 such that the compression limiter 200 is integrated within the mounting tab 14 of the component 10. During a molding process, the compression limiter 200 may be loaded into a mold cavity corresponding to the component 10. Molten material for forming the component 10 is then provided to the mold cavity (e.g., injection molding) and flows around the exterior surface 208 of the bushing 202. The interior conduit 212 may be plugged by a mold feature (e.g., a mold pin) during the molding process to prevent the material of the vehicle component from flowing into the conduit 212, thereby forming a clearance hole for receiving the fastener 100 through the tab body 20.

Furthermore, an end of the mold pin may include an annular grove corresponding to the shape of the retainer ring 40. During the molding process, the material of the tab body 20 flows into the detents 214 at each end 204, 206 of the bushing 202 to form a corresponding protuberance 38 within each of the detents 214. Furthermore, the material flows into the annular groove formed in the mold pin disposed within the conduit 212 to form the retainer ring 40 within the conduit 212 at the second end 206 of the compression limiter 200. The detents 214 cooperate with the protuberances 38 to secure the compression limiter 200 within the tab body 20 of the component 10. Specifically, the detents 214 prevent axial and rotational movement of the compression limiter 200 relative to the socket 30.

In use, the retainer ring 40 formed within the compression limiter 200 is configured to capture the fastener 100 within the tab body 20 prior to installation of the component 10 onto the parent structure. For example, the fastener 100 may be partially threaded into the receptacle 43 of the retainer ring 40 for transportation and storage of the component 10. When the component 10 is installed on the parent structure, the shank 104 of the fastener 100 is aligned with a corresponding mounting hole in the parent structure and the fastener 100 is threaded into the mounting hole. Once the fastener head 102 contacts the second end surface 24 of the tab body 20 and the second end 206 of the compression limiter 200, continued rotation of the fastener 100 causes the threaded portion 106 of the fastener shank 104 to strip the softer material of the inner surface 44 of the retainer ring 40. Thus, the fastener 100 is able to rotate freely relative to the retainer ring 40 and can be further torqued within the mounting holes of the parent structure. As the fastener 100 is torqued, the harder material of the compression limiter 200 prevents the fastener head 102 from deforming the tab body 20.

A number of implementations have been described. Nevertheless, it will be understood that various modifications may be made without departing from the spirit and scope of the disclosure. Accordingly, other implementations are within the scope of the following claims.

What is claimed is:

1. A mounting feature for an attachable component, the mounting feature comprising:
a mounting tab comprising:
tab body including a first end surface and a second end surface formed on an opposite side from the first end surface, a distance from the first end surface to the second end surface defining a thickness of the tab body; and
an inner wall defining a socket having a first width and extending through the thickness of the tab body from a first end at the first end surface of the tab body to a second end at the second end surface of the tab body; and
a retaining feature disposed within the second of the socket and including a receptacle having a second width that is less than the first width of the socket.

2. The mounting feature of claim 1, wherein the retaining feature is an annular retainer ring including an inner surface defining the receptacle and an outer surface formed on an opposite side of the retaining feature than the inner surface.

3. The mounting feature of claim 2, wherein the outer surface of the retaining feature is spaced apart from the inner wall of the socket of the mounting tab.

4. The mounting feature of claim 3, wherein the outer surface of the retaining feature is connected to the inner wall of the socket of the mounting tab by one or more protuberances.

5. The mounting feature of claim 4, wherein the one or more protuberances comprises a plurality of protuberances, each of the protuberances of the plurality of protuberances being spaced apart from one another along the outer surface of the retaining feature.

6. The mounting feature of claim 1, further comprising a compression limiter disposed within the socket of the mounting tab.

7. The mounting feature of claim 6, wherein the compression limiter is disposed between the inner wall of the mounting tab and the retaining feature.

8. The mounting feature of claim 7, wherein the compression limiter extends from the first end of the socket to the second end of the socket.

9. The mounting feature of claim 7, wherein the compression limiter includes an inner surface defining a conduit having a third width that is less than the first width of the socket and greater than the second width of the retaining feature.

10. The mounting feature of claim 9, further comprising a fastener including a shank having a major diameter that is greater than the second width and less than the third width.

11. A mounting feature for an attachable component, the mounting feature comprising:
a mounting tab including an inner wall defining a socket extending through the mounting tab, the socket having a first width; and
a retaining feature comprising a retainer ring disposed within the socket, the retainer ring including an outer surface that is spaced apart from the inner wall of the socket by a gap and an inner surface that is formed on an opposite side from the outer surface and defines a receptacle having a second width that is less than the first width.

12. The mounting feature of claim 11, wherein the inner wall of the mounting tab is cylindrical and retaining feature comprises an annular retainer ring.

13. The mounting feature of claim 12, wherein the annular retainer ring is concentric with the inner wall of the mounting tab.

14. The mounting feature of claim 13, wherein the outer surface of the retaining retainer ring is connected to the inner wall of the socket of the mounting tab by one or more protuberances.

15. The mounting feature of claim 14, wherein the one or more protuberances comprises a plurality of protuberances, each of the protuberances of the plurality of protuberances being spaced apart from one another along the outer surface of the retaining feature.

16. The mounting feature of claim 11, further comprising a compression limiter disposed within the socket of the mounting tab.

17. The mounting feature of claim 16, wherein the compression limiter is disposed between the inner wall of the socket and the retaining feature.

18. The mounting feature of claim 17, wherein the compression limiter includes an inner surface defining a conduit having a third width that is less than the first width of the socket and greater than the second width of the retaining feature

19. The mounting feature of claim 17, wherein the retaining feature is disposed adjacent to an end of the socket of the mounting tab.

20. The mounting feature of claim 11, further comprising a fastener including a shank having a major diameter that is greater than the second width.
